(19) United States
(12) Patent Application Publication
(10) Pub. No.: US 2005/0262819 A1
(43) Pub. Date: Dec. 1, 2005

(54) Lawnmower control assembly

(76) Inventors: Steve J. Weber, Germantown, WI (US); Daniel W. Schaefer, Port Washington, WI (US)

Correspondence Address: MICHAEL BEST & FRIEDRICH, LLP, 100 E WISCONSIN AVENUE, MILWAUKEE, WI, 53202, US

(21) Appl. No.: 10/953,875

(22) Filed: Sep. 29, 2004

Related U.S. Application Data
(63) Continuation-in-part of application No. 10/858,569, filed on Jun. 1, 2004.

(51) Int. Cl. A01D 69/00

(52) U.S. Cl. 56/10.8

(57) ABSTRACT

A control assembly for use with a vehicle having a power take off and a gear shift device. The assembly can include a modular housing and a control that can be movable between a default position and an override position. The assembly can include a terminal block and a control circuit electrically connected to the terminal block and coupled to the modular housing. The assembly can further include an indicator electrically connected to the control circuit and coupled to the modular housing to indicate whether the control circuit is operating according to a default condition or an override condition.

### RELATED APPLICATIONS

This application is a continuation-in-part of and claims priority to U.S. patent application Ser. No. 10/858,569, filed Jun. 1, 2004, the entire contents of which are incorporated by reference herein.

### BACKGROUND OF THE INVENTION

If a riding lawnmower includes a control circuit that controls the cutting operation of the lawnmower based upon the direction that the lawnmower is moving, it may be desirable to provide an override option to allow the operator of the lawnmower to choose to be able to mow while traveling in reverse. This override option minimizes the probability that the control circuit will be permanently disabled due to frustration by the operator of not being able to ever mow while traveling in reverse. Conventional designs either do not provide for an override option, or if they do, the circuits for the override option involve many separate electrical components that must be electrically wired together.

### SUMMARY OF THE INVENTION

In light of these problems, a need exists for a control assembly that simplifies the control circuit with the override option, allows a manufacturer to easily install the control circuit with the override option, and allows an operator to easily access the control circuit with the override option. It may also be desirable to provide the operator of the lawnmower with the ability to disable the override option by providing a removable key. In some embodiments, when the key is removed, the override option cannot be chosen.

In one embodiment, the invention provides a control assembly for use with a vehicle having a power take off and a gear shift device. The control assembly can include a modular housing and a control coupled to the modular housing. The control can be movable between a default position and an override position. The control assembly can also include a terminal block electrically connected to the control and coupled to the modular housing. The control assembly can further include a control circuit electrically connected to the terminal block and coupled to the modular housing. The control circuit can operate according to a default condition when the control is in the default position and according to an override condition when the control is in the override position. The control assembly can also include an indicator electrically connected to the control circuit and coupled to the modular housing. The indicator can signal to an operator whether the control circuit is operating according to the default condition or the override condition.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

FIG. 1 is a perspective view of a lawnmower.

FIG. 2 is a partial perspective view of a lawnmower console.

FIG. 3 is a front perspective view of a control assembly for a lawnmower.

FIG. 4 is a rear perspective view of a control assembly, such as the control assembly of FIG. 3.

FIG. 5 is an exploded view of a control assembly, such as the control assembly of FIG. 3.

FIGS. 6A-6C are schematic diagrams of a control circuit for use in the control assembly of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

Although the invention is shown and described with respect to a lawnmower, some embodiments of the invention can be used with any moving vehicle having a powered attachment, such as a power take off. For example, some embodiments of the invention are suitable for snowblowers, garden tillers, riding tractors, etc.

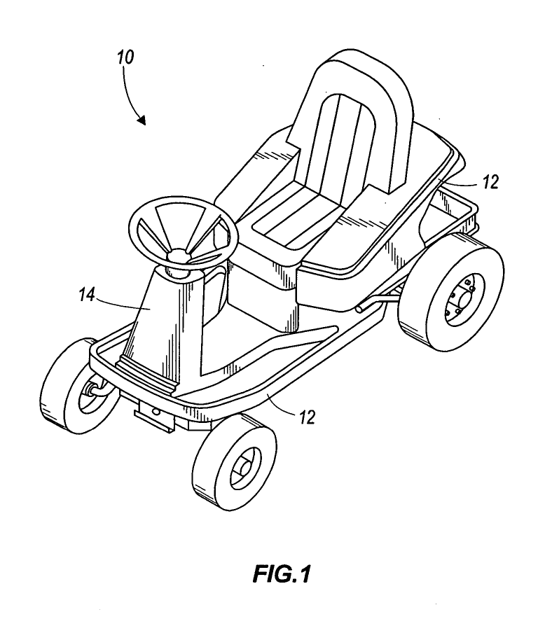

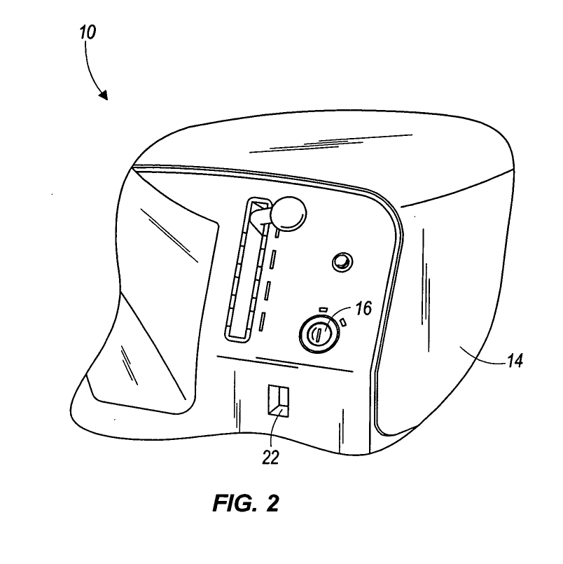

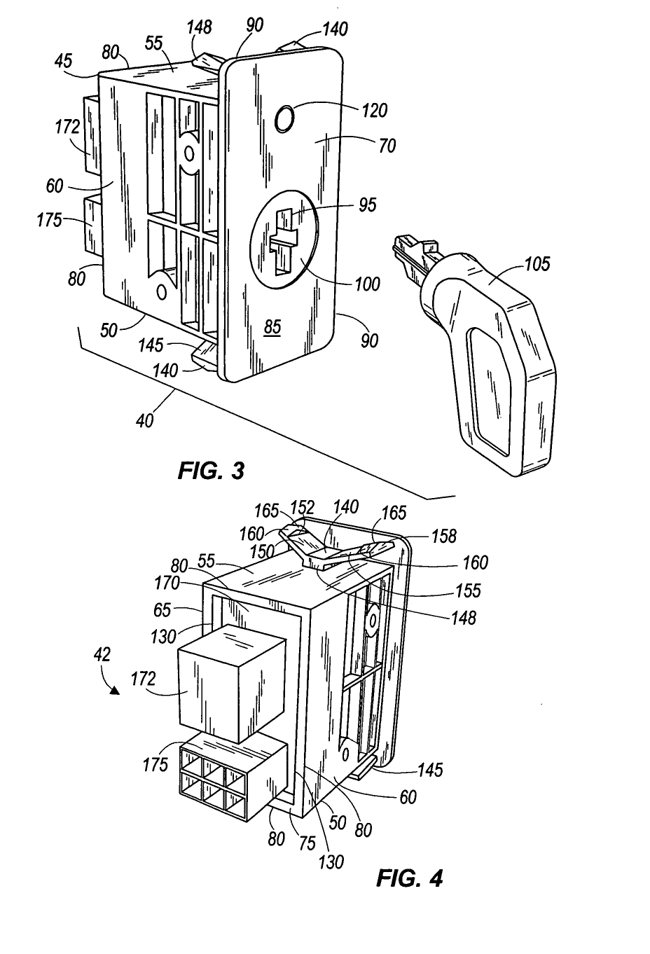

FIG. 1 illustrates a riding lawnmower 10 according to one embodiment of the invention. As shown in FIGS. 1 and 2, the lawnmower 10 can include a housing 12, and the housing 12 can include a console 14. As shown in FIG. 2, the console 14 can include an ignition switch 16 and a gear shift device. The gear shift device can include a lever on the console 14 or a foot pedal coupled to the housing 12. The gear shift device can allow an operator to select the gearing of the lawnmower 10 (e.g., forward, reverse, or neutral). The lawnmower 10 can also include a power take off (not shown) and a cutting apparatus (not shown) covered by the housing 12. The cutting apparatus can include, for example, one or more cutting blades. The power take off and cutting apparatus can be coupled to a clutch (not shown) to control the power take off. Rather than a clutch, the lawnmower 10 can include a switch to control the power take off. The console 14 can include additional switches, controls, and/or indicators, such as, for example, a throttle lever (not shown). The console 14, as shown in FIG. 2, can also define a receiving port 22 that can receive a control assembly 40 (as shown in FIGS. 3-5).

FIGS. 3-5 illustrate the control assembly 40 including a control circuit 42 according to one embodiment of the invention. The control assembly 40 can include a modular housing 45 configured to be inserted into the receiving port 22 (as shown in FIG. 2) by a manufacturer during assembly or by an operator during maintenance. In some embodiments, the control assembly 40 can be installed in the receiving port 22 without using tools. The modular housing 45 can include a plurality of sides, such as a first side 50, a second side 55, a third side 60, a fourth side 65, a top side 70, and a bottom side 75. The first side 50, the second side 55, the third side 60, and the fourth side 65 can form a first perimeter 80. The top side 70 can include a top surface 85 having a second perimeter 90 that can be greater than the first perimeter 80. In some embodiments, the first perimeter 80 of the control assembly 40 can be less than the perimeter of the receiving port 22, and the top side 70 can be configured to substantially close the receiving port 22 when the control assembly 40 is inserted into the receiving port 22.

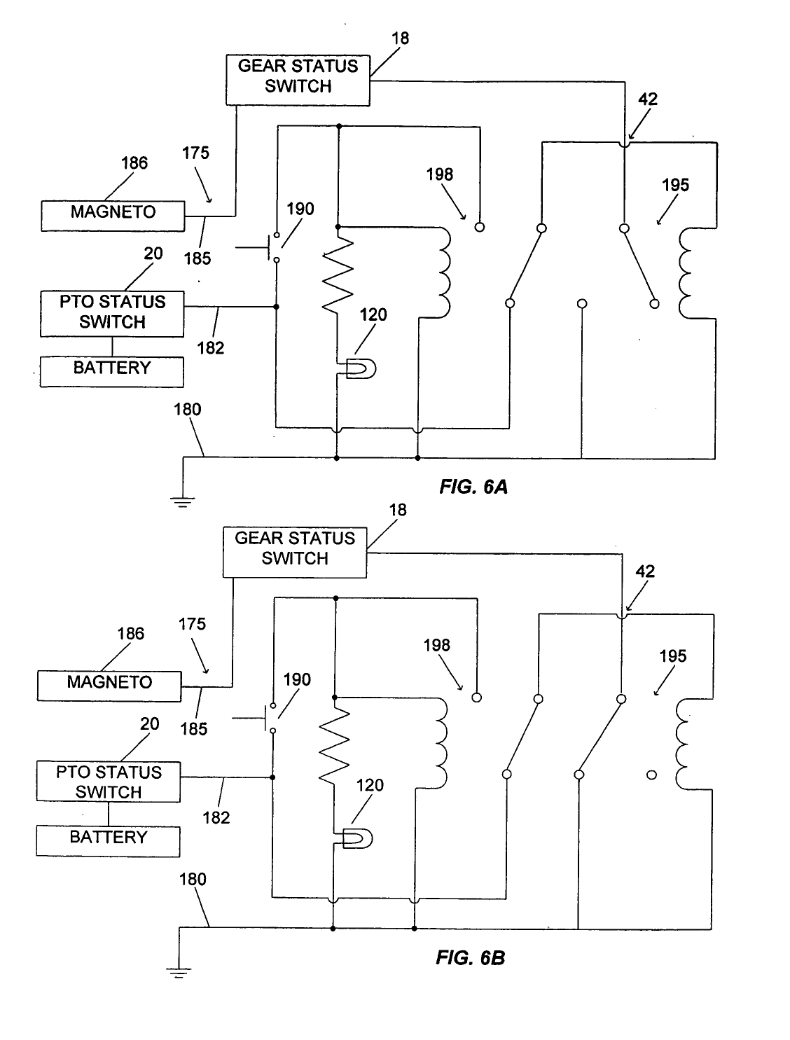

The top side 70 of the control assembly 40 can include a control 95 that can be manipulated by the lawnmower operator. More specifically, the control 95 can allow an operator to activate and deactivate an override option, which in turn, allows an operator to enable or disable the operation of the lawnmower 10 (or a power take off attachment on any suitable vehicle or machine, such as a snowblower) when moving in the reverse direction. In some embodiments, the control 95 can include a key cylinder 100 that is adapted to receive a key 105 (which can be either removable or non-removable from the key cylinder 100). In some embodiments, the key 105 is removable and provided for security purposes so that unauthorized operators cannot operate the mower or other power take off attachment while traveling in reverse. The control 95 can include a bias member 96 (as shown in FIG. 5) for biasing the control 95 into a particular position. For example, the control 95 can be biased by the bias member 96 into a position corresponding to a default condition. Rather than a key cylinder and a key, the control 95 can include any other suitable control, such as, for example, a switch, a push button, a key pad, etc.

The top surface 85 of the control assembly 40 can include an indicator 120. The indicator 120 can signal to an operator the current state of the override option. In some embodiments, the indicator 120 can include a light-emitting diode (LED) and a cylindrical housing, as shown in FIG. 5. In some embodiments, after the operator activates the override option via the control 95, the indicator 120 can be illuminated as long as the override option is activated. In other embodiments, the control assembly 40 can include other suitable controls 95 and/or indicators 120, such as, for example, an alarm, a buzzer, a mechanical switch, etc. For example, a mechanical switch can include a first physical position that provides for and indicates that the override option is disabled and a second physical position that provides for and indicates that the override option is enabled.

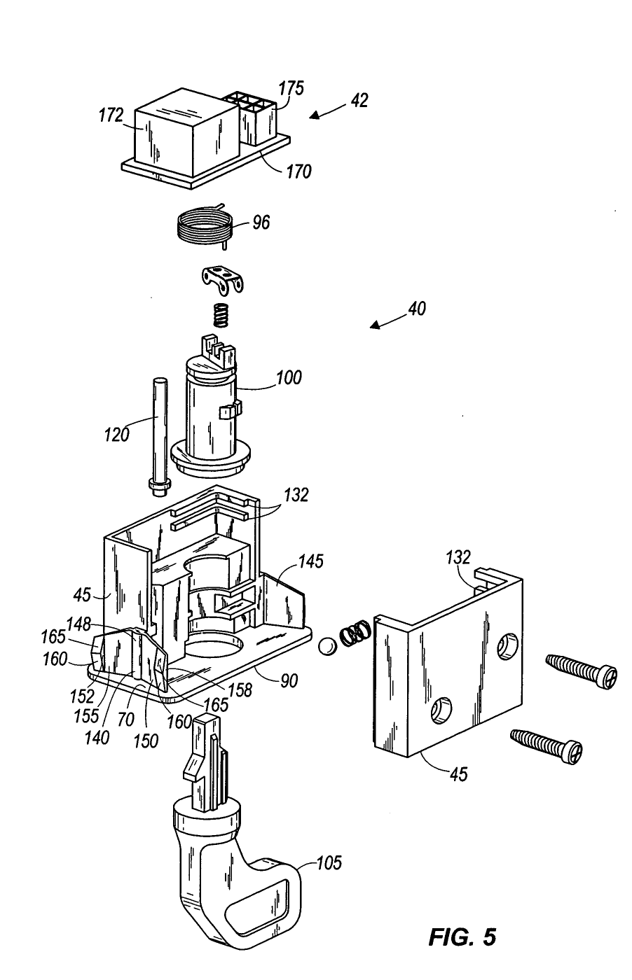

As shown in FIG. 4, the bottom side 75 of the housing 45 can define an aperture 130. As shown in FIG. 5, the housing 45 can include one or more protrusions 132 positioned within the interior surfaces of the first side 50, the second side 55, the third side 60, and the fourth side 65. The protrusions 132 can aid with the positioning of the control circuit 42 within the housing 45.

As shown in FIGS. 4 and 5, the control assembly 40 can include one or more locking members 140 to secure the control assembly 40 within the receiving port 22. In some embodiments, the control assembly 40 can include a first resilient tab 145 and a second resilient tab 148 as first and second locking members 140, respectively. In some embodiments, each resilient tab 145 and 148 can include a first wing 150 having a first raised portion 152 and a second wing 155 having a second raised portion 158. The raised portions 152 and 158 can each include a ramped surface 160 and a grooved surface 165. During insertion into the receiving port 22, the ramped surface 160 can help guide the locking member 140 past a protrusion (not shown) within the receiving port 22, and the grooved surface 165 can help prevent the control assembly 40 from falling out of the receiving port 22. As shown in FIGS. 3-5, the first locking member 145 can be positioned on the first side 50 of the housing 45, and the second locking member 148 can be positioned on the second side 55 of the housing 45. In other embodiments, the control assembly 40 can include more or fewer locking members 140 than those shown and described and can be positioned at different locations on the housing 45 than those shown and described.

As shown in FIG. 5, the control circuit 42 can include a printed circuit board 170, circuit elements 172, and a terminal block 175. The circuit elements 172 of the control circuit 42 can be positioned on and coupled to the printed circuit board 170. In one embodiment, the printed circuit board 170 can at least partially rest on the protrusions 132 of the housing 45. In some embodiments, the printed circuit board 170 can couple the circuit elements 172 of the control circuit 42 to the terminal block 175. The terminal block 175 can electrically connect the control circuit 42 to the gear shift 18 and the clutch 20 when the control assembly 40 is inserted into the receiving port 22 of the lawnmower 10. In some embodiments, the terminal block 175 can also electrically connect the control circuit 42 to a start circuit.

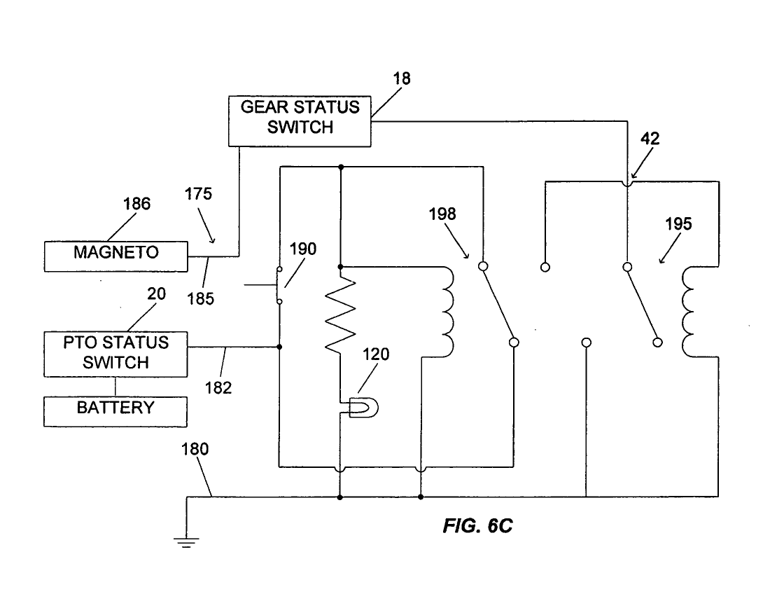

FIGS. 6A-6C schematically illustrate several states of the control circuit 42 according to one embodiment of the invention. The terminal block 175 can include a first terminal 180, a second terminal 182, and a third terminal 185. In some embodiments of the invention, the terminal block 175 can include additional terminals, for example with two of the additional terminals incorporating a start circuit. With the start circuit included in the terminal block 175, the lawnmower operator is prevented from tampering with the start circuit (e.g., intentionally disconnecting the switch).

The first terminal 180 can be connected to a ground. The second terminal 182 can be connected to a power take off status switch 20. The power take off status switch 20 can be connected between the second terminal 182 and a clutch (not shown). The power take off status switch 20 can be connected to a battery providing voltage to the control circuit 42 when the power take off is turned ON. In other words, the power take off status switch 20 can be closed when the power take off is turned ON and open when the power take off is turned OFF.

The third terminal 185 can be connected to a gear status switch 18. The gear status switch 18 can be connected between the third terminal 185 and a gear shift device. The gear status switch 18 can be a normally-open switch and can provide a path from an engine magneto 186 to ground when the lawnmower 10 is shifted in reverse and the power take off is turned ON. The gear status switch 18 can remain open as long as it senses that the gear shift device is in a forward or neutral position. The gear status switch 18 can close when it senses that the gear shift device is in a reverse position. The third terminal 185 can also be connected to the engine magneto 186, which can provide a path to ground to stop the engine. In other embodiments, rather than grounding the engine, power can be cut in order to stop the engine. In one embodiment, power can be cut to a fuel injector in a diesel engine in order to stop the engine.

The control circuit 42 can include an override switch 190 having an open position (corresponding to a default condition) and a closed position (corresponding to an override condition). The control circuit 42 can further include the indicator 120 (as also shown in FIGS. 3 and 5), a reverse circuit relay 195, and an override relay 198.

As shown in FIGS. 6A and 6B, the control circuit 42 can operate according to a default condition. The default condition can prohibit cutting or operating with the power take off turned ON when the lawnmower 10 is moving in the reverse direction. For the default condition, the override switch 190 is in the open position. In some embodiments, the override switch 190 can be biased in the open position by the bias member 96 (as shown in FIG. 5).

FIG. 6A illustrates the default condition when the gear shift device is in the forward, neutral, or reverse positions and the power take off is OFF. As shown in FIG. 6A, the override switch 190 is open, the reverse circuit relay 195 is deactivated, and the override relay 198 is deactivated. There is no path to ground so the lawnmower can operate in reverse with the power take off turned OFF.

FIG. 6B illustrates the default condition when the power take off is turned ON. As shown in FIG. 6B, the override switch 190 is open, the reverse circuit relay 195 is activated, and the override relay 198 is deactivated. If the lawnmower is shifted in reverse, the gear status switch 18 is closed creating a current path to ground which will stop the engine and prevent operating in reverse. The power take off status switch 20 is closed in order to provide power to the control circuit 42 through the operation of the clutch. A path is created via the operation of the clutch past the activated reverse circuit relay 195 to ground. In summary, if the lawnmower is shifted into reverse, the normally-open gear status switch 18 closes, thus completing a circuit between the magneto 186 and ground, which will shut down the engine. In other embodiments, rather than closing immediately after shifting into reverse, the gear status switch 18 can close after the lawnmower has started moving in the reverse direction and has exceeded a certain speed in the reverse direction (e.g., up to 1 foot per second or 0.7 miles per hour).

As shown in FIG. 6C, the control circuit 42 can operate according to an override condition. The override condition can enable the override option and allow operating of the power take off when the lawnmower 10 is moving in the reverse direction. For the override condition, the override switch 190 is momentarily in the closed position. FIG. 6C also illustrates that the gear shift device can be in any one of the neutral, forward, or reverse positions when the power take off is turned ON. As shown in FIG. 6C, the reverse circuit relay 195 is deactivated and the override relay 198 is activated, turning the indicator 120 ON. The power take off status switch 20 is closed in order to provide power to the control circuit 42 through the operation of the clutch. As a result, the override switch 190 and the override relay 198 provide a self-latching override circuit that allows the control circuit 42 to remain in the override condition until either the power take off is turned OFF or the engine is shut down. When the lawnmower is operating in the reverse direction, current can flow through the closed gear status switch 18, but the circuit to the magneto 186 is not closed. In this manner, the power take off remains ON and the engine remains running during the override condition while the lawnmower 10 is operating in any one of neutral, forward, or reverse. In summary, there is no longer a circuit between the magneto 186 and ground, thus the engine does not shut down when the lawnmower 10 is shifted into reverse.

In some embodiments, the override switch 190, the reverse circuit relay 195, and the override relay 198 can be included in a single integrated circuit (IC). In one embodiment, the override switch 190 is a momentary switch and the reverse circuit relay 195 and the override relay 198 are included in a double pole, double throw relay. In other embodiments, the control circuit 42 can be implemented using an IC with digital logic components.

In general, all the embodiments described above and illustrated in the figures are presented by way of example only and are not intended as a limitation upon the concepts and principles of the invention. As such, it will be appreciated by one having ordinary skill in the art that various changes in the elements and their configuration and arrangement are possible without departing from the spirit and scope of the invention as set forth in the appended claims.

1. A control assembly for use with a vehicle having an engine, a power take off, and a gear shift device, the control assembly comprising:
a modular housing;
a control coupled to the modular housing, the control being movable to select a default position and an override position;
a terminal block electrically connected to the control and coupled to the modular housing;
a control circuit electrically connected to the terminal block and coupled to the modular housing, the control circuit operating according to a default condition that does not allow at least one of the engine and the power take off to operate when the gear shift device is in reverse and the control has been used to select the default position, the control circuit operating according to an override condition that allows the engine and the power take off to operate when the gear shift device is in reverse and the control has been used to select the override position; and
an indicator electrically connected to the control circuit and coupled to the modular housing, the indicator signaling to an operator whether the control circuit is operating according to the default condition or the override condition.

2. The control assembly of claim 1 wherein the control includes a key cylinder and a key.

3. The control assembly of claim 1 wherein the control includes a manually-operated switch.

4. The control assembly of claim 1 wherein the indicator is a light-emitting diode.

5. The control assembly of claim 1 wherein the control circuit includes an override switch and at least one relay.

6. The control assembly of claim 1 wherein the control circuit includes an override switch and an integrated circuit.

7. The control assembly of claim 1 wherein the terminal block is adapted to be coupled to the power take off via a clutch and is adapted to be coupled to the gear shift device via one of a gear shift lever and a foot pedal.

8. The control assembly of claim 1 wherein the control circuit returns to the default condition when the engine is shut down.

9. The control assembly of claim 1 wherein the control circuit returns to the default condition when the power take off is turned off.

10. The control assembly of claim 1 wherein the modular housing includes at least one angled tab adapted to be positioned within an aperture in the vehicle in order to secure the modular housing to the vehicle without additional fasteners.

11. The control assembly of claim 1 wherein the vehicle is one of a lawnmower, a snowblower, a garden tiller, and a riding tractor.

12. A control assembly for use with a vehicle having a power take off and a gear shift device, the control assembly comprising:
a modular housing adapted to be removably coupled to the vehicle;
a key cylinder rotatably positioned in the modular housing and a key removably positioned in the key cylinder, the key cylinder being movable via the key to select a default position and an override position;
a circuit board including a control circuit, the circuit board coupled to the modular housing, the control circuit operating according to a default condition that does not allow at least one of the engine and the power take off to operate when the gear shift device is in reverse and the key cylinder has been used to select the default position, the control circuit operating according to an override condition that allows the engine and the power take off to operate when the gear shift device is in reverse and the key cylinder has been used to select the override position;
a terminal block coupled to the circuit board and the modular housing; and
an indicator coupled to the modular housing to signal to an operator whether the control circuit is operating according to the default condition or the override condition.

13. The control assembly of claim 12 wherein the indicator is a light-emitting diode.

14. The control assembly of claim 12 wherein the control circuit includes an override switch and at least one relay.

15. The control assembly of claim 12 wherein the control circuit includes an override switch and an integrated circuit.

16. The control assembly of claim 12 wherein the terminal block is adapted to be coupled to the power take off via a clutch and is adapted to be coupled to the gear shift device via one of a gear shift lever and a foot pedal.

17. The control assembly of claim 12 wherein the control circuit returns to the default condition when an engine of the vehicle is shut down.

18. The control assembly of claim 12 wherein the control circuit returns to the default condition when the power take off is turned off.

19. The control assembly of claim 12 wherein the modular housing includes at least one angled tab adapted to be positioned within an aperture in the vehicle in order to secure the modular housing to the vehicle without additional fasteners.

20. The control assembly of claim 12 wherein the vehicle is one of a lawnmower, a snowblower, a garden tiller, and a riding tractor.
